(19) United States
(12) Patent Application Publication
(10) Pub. No.: US 2017/0053118 A1
(43) Pub. Date: Feb. 23, 2017

(54) Changed Block Tracking Driver for Agentless Security Scans of Virtual Disks

(71) Applicants: Konstantin Malkov, Middletown, NJ (US); Pavel Koptev, Moscow (RU)

(72) Inventors: Konstantin Malkov, Middletown, NJ (US); Pavel Koptev, Moscow (RU)

(21) Appl. No.: 15/240,100

(22) Filed: Aug. 18, 2016

Related U.S. Application Data
(60) Provisional application No. 62/206,788, filed on Aug. 18, 2015.

(51) Int. Cl. G06F 21/56; G06F 9/455; G06F 21/55

(52) U.S. Cl. CPC G06F 21/56; G06F 21/554; G06F 9/45558; G06F 2009/45583

(57) ABSTRACT

An agentless system and method of efficiently scanning a computer memory for compromised security in a virtualized computing environment is disclosed. By monitoring the access from virtual processing machines to a physical memory device, a list of the data blocks that have been altered since a last security scan is compiled. The system then uses that list to only scan altered data block in a subsequent security scan.

### PRIORITY/CROSS REFERENCE TO RELATED APPLICATIONS

This application is the Non-Provisional Application of Provisional Application No. 62/206,788 (Confirmation No. 7483), filed on Aug. 18, 2015 for “Changed Block Tracking Driver for Fast Agentless Incremental Security Scans of Hyper-V Virtual Disks Stored on NTFS Partitions in Windows Server OS” by Konstantin Malkov and Pavel Koptev (EFS ID 23245185). This Non-Provisional Application claims priority to and the benefit of that Provisional Application, the contents and subject of which are incorporated herein by reference in their entirety.

### SUMMARY

An inventive system and method of scanning a digital computer memory in a virtualized computing environment is disclosed. More particularly, an agentless system and method of efficiently scanning a computer memory for compromised security in a virtualized computing environment is disclosed. By monitoring the access from virtual processing machines to a physical memory device, such, as for instance, the memory capability of a physical storage device, such as a hard disk drive (including solid state drives), a list of the data blocks that have been altered since a last security scan is compiled. The system then uses that list to only scan altered data block in a subsequent security scan.

As used herein, the term host digital machine or host machine refers to the actual physical machine upon which one or more virtual machines (VMs) may operate. The host machine is typically comprised of a digital processor or CPU that may have some associated volatile memory, typically in the form of RAM, a digital storage device typically in the form of a hard disk drive (including, but not limited to, solid state drives) that may serve as the main digital memory associated with the digital processor and where files and other associated data are typically stored, a network communications device, such as a network interface controller (NIC) or device, and other hardware commonly known and understood and upon which one or more operating systems and various software platforms or layers operate to comprise the entire host machine and upon which one or more virtual machines (VMs) operate. The digital processor of the host machine is referred to herein as the host processor or host digital processor. Further, as used herein, the terms digital memory, disk memory, digital disk memory and memory are used interchangeably and are generally intended as meaning the memory capability of the host disk drive, although without departing from the spirit and scope of the embodiments, additional forms of memory may be encompassed. It is also to be understood that host machines may employ multiple digital processors, digital storage devices, memory devices, etc. in various configurations commonly known.

### BACKGROUND

(1) Machine Virtualization

Server virtualization has evolved over the past few years from a nascent technology into a mature information technology (IT) feature. By virtualizing their workloads, organizations can control and cut costs while improving the scalability, flexibility, and reach of IT systems.

Machine virtualization is implemented through a hypervisor or virtual machine monitor (WM). A hypervisor or VMM is a piece of computer software, firmware or hardware that creates and runs virtual machines. A computer on which a hypervisor runs one or more virtual machines is called a host machine, and each virtual machine is called a guest machine. The hypervisor presents the guest operating systems (OSs) with a virtual operating platform and manages the execution of the guest operating systems. The hypervisor manages the system's processor, memory, and other resources to allocate what each operating system requires. Multiple instances of a variety of operating systems may share the virtualized hardware resources: for example, Linux, Windows® and OS X® instances can all run on a single physical x86 machine. This contrasts with operating-system-level virtualization, where all instances must share a single kernel, though the guest operating systems can differ in user space, such as different Linux distributions with the same kernel.

(2) Hyper-V Server Virtualization

With advances in server virtualization, however, comes the realization that virtualization by itself does not allow organizations to build or take advantage of cloud services, which are assuming an ever-growing role in the execution of business tasks.

Hyper-V® by Microsoft Corporation, Redmond Wash., codenamed “Viridian” and formerly known as Windows Server Virtualization, is a native hypervisor; it can create virtual machines on x86-64 systems running Windows®. First introduced as part of Windows Server 2008, expanded and enhanced in Windows Server 2008 R2, and enhanced still further with Windows Server 2012, Hyper-V® provides organizations with a tool for optimizing server hardware investments by consolidating multiple server roles as separate virtual machines running on a single physical host machine. A server computer running Hyper-V® can be configured to expose individual virtual machines to one or more networks.

(3) Hyper-V® Architecture

Hyper-V® implements isolation of virtual machines in terms of a partition. A partition is a logical unit of isolation, supported by the hypervisor, in which each guest operating system executes. A hypervisor instance has to have at least one parent partition, running a supported version of Windows Server (2008 and later). The virtualization stack runs in the parent partition and has direct access to the hardware devices. The parent partition then creates the child partitions which host the guest OSs. A parent partition creates child partitions using the hypercall API, which is the application programming interface exposed by Hyper-V®.

A child partition does not have access to the physical processor, nor does it handle its real interrupts. Instead, it has a virtual view of the processor and runs in guest virtual address, which, depending on the configuration of the hypervisor, might not necessarily be the entire virtual address space. Depending on VM configuration, Hyper-V® may expose only a subset of the processors to each partition. The hypervisor handles the interrupts to the processor, and redirects them to the respective partition.

Child partitions also do not have direct access to hardware resources, but instead have a virtual view of the resources, in terms of virtual devices. Any request to the virtual devices is redirected to the devices in the parent partition, which will manage the requests. This entire process is transparent to the guest OS.

(4) Field of the Invention

The invention relates to security arrangements for protecting computers against unauthorized activity, and more particularly, to the agentless protection of a virtual processing-machine against malware, including computer viruses, through the use of software that may include a changed block tracking driver.

“Malware,” short for “malicious software,” is any software used to disrupt computer operations, gather sensitive information, gain access to private computer systems, or display unwanted advertising. It is defined by its malicious intent, acting against the requirements of the computer user. It is an umbrella term used to refer to a variety of forms of hostile or intrusive software, including computer viruses, worms, Trojan horses, ransomware, spyware, adware, scareware, and other malicious programs. It can take the form of executable code, scripts, active content, and other software, and is often disguised as, or embedded in, non-malicious files.

As used herein, the term “malware” is intended as broad and comprehensive meaning as possible.

(5) Description of the Related Art

The technical problem of performing efficient scanning of digital data stored on a digital disk memory, i.e., digital data stored on a hard disk drive, etc., for the purpose of checking for malware, such as, but not limited to, computer viruses, is inherent in the technical field of computer operations.

The problem has become more complex now that many systems operate virtualized computing environments in which a single physical host machine supports a number of virtual machines, each effectively functioning as an independent computer. Each virtual machine may run its own operating system, supporting one or more user applications, and may have an associated virtual memory, which resides on or within the digital disk memory of the host machine.

There are two basic approaches to protect such virtual machines against malware. In one approach, each virtual machine operates its own “anti-malware” software in the form of an agent operating on that virtual machine. This agent, or anti-malware software, may, for instance, take the form of modules such as, but not limited to, a firewall, a virtual disk scanner, or some combination thereof. In such cases, the anti-malware software may, for instance, examine system, software and data files for signatures of known computer malware. Having each virtual machine operate its own anti-malware agent is, however, expensive in terms of computing resources and can lead to conflicts in scheduling computing resources if multiple virtual machines on a single physical host machine or system request security scans at the same time. As a result, computing operations slow, resulting in inefficiency and sluggishness of the virtual machines.

A second approach to protecting virtual machines on a single physical host machine or system from malware is to instead have the anti-malware protection software operate on the machine hosting the virtual machines. This is more efficient in terms of computing resources. This approach, however, presents challenges in terms of effectively tailoring the anti-malware protection software so as to properly protect each virtual machine being hosted. Prior art systems have failed to provide manageable solutions to this problem.

The relevant prior art includes the following matters.

U.S. Pat. No. 9,268,647 issued to Mam et al. on Feb. 23, 2016 entitled “Block based incremental backup from user mode” describes a system for incremental backup comprising a storage device and a processor. The processor is configured to: 1) start Event Tracing for Windows tracking, to track changed block information in one or more maps, where each of the one or more maps tracks writes indicated via a node; 2) receive request for an incremental backup of a volume of one or more volumes, wherein the one or more maps track changed blocks from writes to the volume; 3) halt writes to the volume and queue writes to the volume after halting; 4) freeze the one or more maps of changed blocks; change Event Tracing for Windows tracking, wherein the change block info is tracked to a new set of maps; 5) determine changed blocks using the one or more maps; 6) write changed blocks to a backup volume; and 7) release writes to the volume.

U.S. Pat. No. 9,032,171 issued to Niles et al. on May 12, 2015 entitled “System and method for backing up data” describes a hash-optimized backup system and method that analyzes data blocks and generates a probabilistically unique digital fingerprint of the content of each data block using a substantially collision-free algorithm. The process compares the generated fingerprint to a database of stored fingerprints and, if the generated fingerprint matches a stored fingerprint, the data block is determined to already have been backed up, and therefore does not need to be backed up again. Only if the generated fingerprint does not match a stored fingerprint is the data block backed up, at which point the generated fingerprint is added to the database of stored fingerprints. Because the algorithm is substantially collision-free, there is no need to compare actual data content if there is a hash-value match. The process can also be used to audit software license compliance, inventory software, and detect computer-file tampering such as viruses and malware.

U.S. Pat. No. 5,794,254 issued to McClain on Aug. 11, 1998 entitled “Incremental computer file backup using a two-step comparison of first two characters in the block and a signature with pre-stored character and signature sets” describes a system that backs up computer files to a remote site via modem. Files of a user computer that are found in a common library at the remote site initially are not copied to the remote site, whereas files not in the library are copied to the remote site. The user computer then periodically determines which blocks have been changed, and the user computer transmits only changed blocks to the remote site. The blocks are gathered in “chunk” files, and when a chunk file reaches a predetermined size, it is transmitted to the remote site for updating the backup version of the respective file. The process then resumes identifying changed blocks. In addition to flagging the changed block for transfer, the process resynchronizes the local data file with the backed up version using a two-step comparison, first comparing the first two characters in the block with a pre-stored character set, and then, if the first comparison results in a match, comparing a digital signature of the changed block with a pre-stored signature. If either comparison results in a mismatch, the test is repeated using, as the first byte of the test block, the next byte in the sequence.

Various implementations are known in the art, but fail to address all of the problems solved by the invention described herein. Various embodiments of this invention are illustrated in the accompanying drawings and will be described in more detail herein below.

### BRIEF SUMMARY OF THE INVENTION

An inventive system and method of scanning a digital computer memory in a virtualized computing environment is disclosed.

In an embodiment, an agentless method of scanning a digital memory of a virtual machine for compromised security, such as that caused by malware, may operate by monitoring the access from one or more virtual digital processing machines to a physical digital memory storage device, e.g., a hard disk drive or the respective portions thereof portioned and/or otherwise associated with the virtual processing machine, comprising the associated physical host processor or machine. The result of such monitoring may be to compile a changed block list that may, for instance, be a list of the block addresses of the digital data blocks of the digital memory storage device that have been accessed since a last security scan of the disc was undertaken.

When a next security scan is requested, the system may then use the changed block list to select only the portions of the memory that have been accessed since the last scan. These, and only these, changed blocks may then be scanned looking for the presence of malware. In this way security scans can be performed in a more efficient manner, saving time and computing resources.

In an embodiment, traffic between one or more virtual digital processing machines and the physical, digital memory storage device associated with a digital host processor, may be monitored by a file system driver. The file system driver may, for instance, be a software module, operative in a kernel mode as part of, or as an extension to, a memory management module that may be part of a hypervisor software module managing the digital processing machines or virtual machines (VMs), hosted by a single, physical host machine.

In a more particular embodiment, the memory management module may implement a journaling file system, thereby providing the file system driver with efficient access to data necessary to compile a changed block list. In this way, only digital data blocks that have been both accessed and altered since a last security scan may be noted and then scanned for malware in a subsequent security scan, thereby making the security scan process efficient by minimizing use of computing resources. The security scan may, for instance, include comparing the files in the changed block list with signatures of known malware. Therefore, the present invention succeeds in conferring the following, and others not mentioned, desirable and useful benefits and objectives.

It is an object of the present invention to provide an efficient, agentless method of scanning a digital memory for compromised security, particularly that caused by, but not necessarily limited to, malware.

It is another object of the present invention to provide a system and method for enhancing security in a virtualized computing environment.

Yet another object of the present invention is to provide a security management system that is tightly coupled to a hypervisor memory management system.

### BRIEF DESCRIPTION OF THE SEVERAL VIEWS OF THE DRAWINGS

FIG. 1 shows a schematic layout of a virtualized information technology environment in which multiple virtual digital processing machines are operative on a single digital physical host machine.

FIG. 2 shows a schematic layout of the management of memory in one embodiment of a virtualized information technology environment.

FIG. 3 shows a schematic flow-diagram of steps for implementing a changed block tracking driver for agentless security scans of virtual disks of one embodiment of the present invention.

### DETAILED DESCRIPTION OF THE INVENTION

The various embodiments of the present invention will now be described in more detail with reference to the drawings in which identical elements in the various figures are, as far as possible, identified with the same reference numerals. These embodiments are provided by way of explanation of the present invention, which is not, however, intended to be limited thereto. Those of ordinary skill in the art may appreciate upon reading the present specification and viewing the present drawings that various modifications and variations may be made thereto.

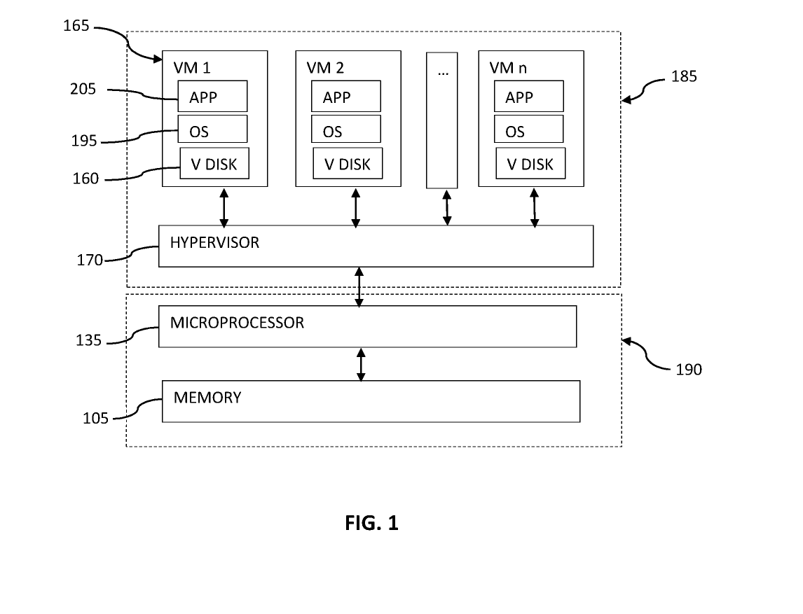

FIG. 1 shows a schematic layout of a virtualized information technology environment in which multiple virtual digital processing machines are operative on a single digital physical host machine.

The system may be understood as two distinct layers: a hardware layer 190 and a software layer 185 operative on the hardware layer.

The hardware layer 190 may, for instance, be the physical components such as, but not limited to, a digital host processor or CPU 135 and an associated digital memory storage device 105, such as, for example, a digital hard disk drive (including, without limitation, solid state drives). These may, for instance, be any of the well-known digital computing processors and digital electronic memory/storage devices that are commercially available.

In an embodiment, the software layer 185 may be an implementation of a virtual computing environment in which a hypervisor software module 170 may implement one or more virtual digital processing machines 165. Each of the virtual digital processing machines 165, also known as Virtual Machines or VMs, may have a guest operating system 195 that may be associated with a virtual digital memory (virtual disk) 160 and may run one or more guest software applications 205.

Each virtual digital processing machine 165 may appear to an end user to be functionally equivalent to a physical digital machine, allowing applications such as, but not limited to, word processors, spreadsheets and databases or other software applications and platforms, or some combination thereof, to be used. Each virtual digital processing machine 165 may operate its own and separate operating system (OS) such as, but not limited to, Microsoft Windows®, Apple OS or Linux open source operating system, all of which may run or operate as a guest operating system 195 on the virtual digital processing machine 165.

Translating the instructions issued by the guest software programs or applications 205 operating on each VM 165 into actions that can be performed by the digital host processor 135 may be accomplished by a hypervisor software module 170. The hypervisor software module 170 may, for instance, be one of the well-known virtualization platforms such as, but not limited to, one of the Hyper-V® family of software platforms provided by the Microsoft Corporation of Redmond, Wash., discussed previously. While the Hyper-V® family of hypervisor platforms is considered herein as an example, it is expressly understood that the disclosed embodiments of the invention are not in any way limited to that specific hypervisor module.

The hypervisor software module 170 may, for instance, translate requests by a VM 165 to access its virtual digital memory (virtual disk) 160 into access to the physical, digital memory storage device 105 associated with the host processor 135.

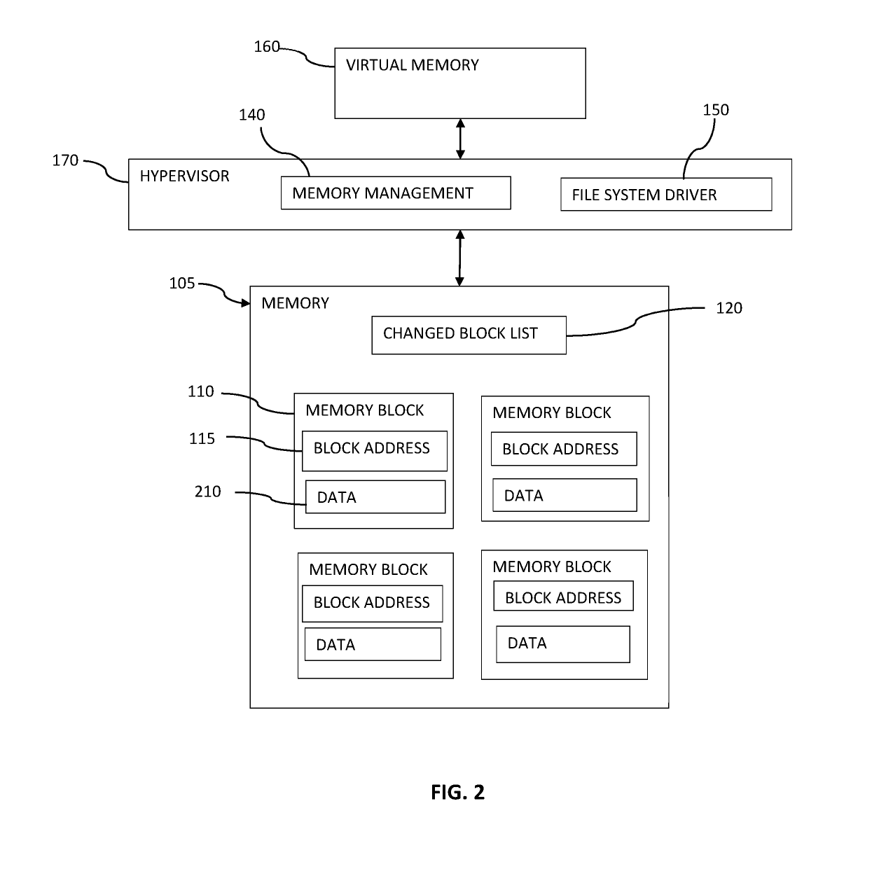

FIG. 2 shows a schematic layout of the management of memory in one embodiment of a virtualized information technology environment, i.e., between virtual digital memory (virtual disk) 160 and the physical, digital memory storage device 105 associated with the host processor 135.

For example, a guest program's 205 access to a virtual machine's virtual digital memory 160 may be translated by a hypervisor software module's 170 memory management module 140 for access to and storage in a physical, digital memory storage device 105.

The digital memory storage device 105 may, for instance, be arranged into one or more digital data blocks 110 which may be actual physical locations for storing digital data that comprise and translate to respective portions of virtual digital memory 160. Each digital data block 110 may store guest data files 210 in a data storage region that may be accessed via the digital data block's 110 block address 115.

In an embodiment of the invention, a file system driver 150 that may be an extension of the hypervisor software module 170, and be closely coupled to a memory management module 140 operative on the hypervisor software module 170, may be used to monitor access to the digital memory storage device 105. In particular, the file system driver 150 may monitor read/write instructions from particular virtual machines to the digital memory storage device 105 and use that data to compile a changed block list 120. The changed block list 120 may, for instance, be a list of the block addresses 115 of digital data blocks 110 that have been accessed since the last time a security scan has been performed on either the digital memory storage device 105, or portions of the digital memory in which data (comprising virtual memory 160 or portions thereof) from a particular VM 165 is stored.

In this way, future, or next security scans, may utilize the changed block list 120 so that only digital data blocks 110 that have been altered since the last security scan may need to be examined for evidence of malware, thereby reducing the time needed to perform such security scans and making more efficient use of computing resources.

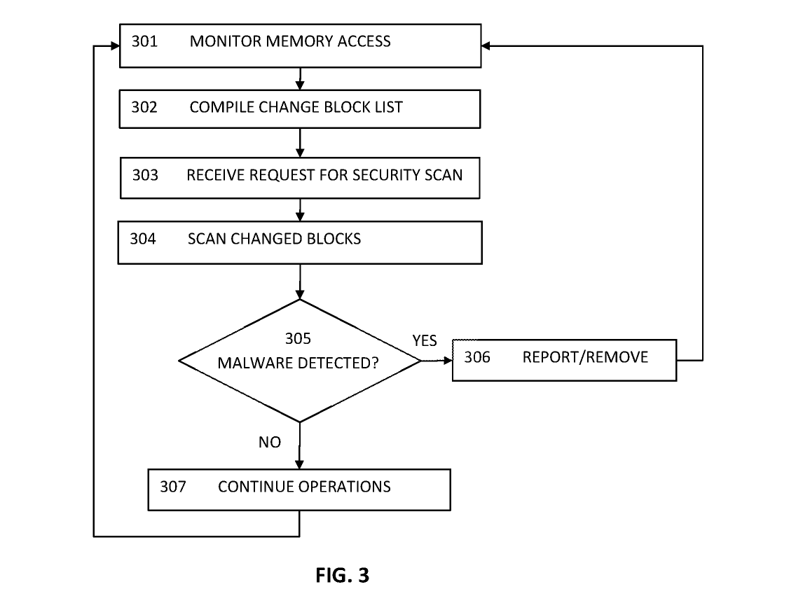

FIG. 3 shows a schematic flow-diagram of steps for implementing a changed block tracking driver for agentless security scans of virtual disks of one embodiment of the present invention.

In Step 301, “Monitor Memory Access,” a computer module may monitor what portions of a digital information memory storage device 105 are accessed. This access may, for instance, be to store information, to retrieve stored information, or to alter stored information or some combination thereof.

In an embodiment, the monitoring may be performed by a file system driver that may be operating in a kernel-mode as an extension to, or part of, a hypervisor executive module. In the instance when the hypervisor software module may have a memory management module that may be operating a journaling file system, such as, but not limited to, to the New Technology File System (NTFS™) provided by the Microsoft Corporation, Redmond, Wash., such monitoring may take advantage of information recorded for backing up, or remounting, databases such as, but not limited to, data moves performed by the defragmentation API, modifications to Master File Table (MFT) records, such as moves of variable-length attributes stored in MFT records and attribute lists, and indices for directories and security descriptors or some combination thereof.

In Step 302, “Compile Change Block List,” the system may compile a list 120 of the block addresses 115 of digital data blocks 110 in the digital memory storage device 105 that may have been altered since a predefined time that may be the time of a previous, or a last, request for a security scan. This changed block list 120 may be stored in another part of the digital memory storage device 105, or it may be sent to another device.

In Step 303, “Receive Request for Security Scan,” the system may receive a request to perform a security scan. The request may be for a security scan of the entire digital memory storage device 105, or it may be for sectors of the storage device 105 used by one or more particular VMs 165.

Requests for security scans may be pre-set on a virtual machine by virtual machine basis using a management system that may be used to set up the file system driver 150 and that may be an extension of, or part of, the memory management module 140 or of the hypervisor software module 170.

In Step 304, “Scan Changed Blocks,” the system may now access the changed block list 120 and may use that list to compile a set of digital data blocks 110 to be scanned. The set of digital data blocks 110 to be scanned may depend on whether the security scan is for the entire digital memory storage device 105 or merely for portions of the storage device 105 impacted by regions of the device allocated to the virtual digital memory 160 of one or more of the VMs 165 being supported on the digital host processor 135 of the host machine.

The security scan may, for instance, be a scan of the digital memory 105 comparing sections of it to definition files that may contain the latest available signatures of known malware.

In Step 305, “Malware Detected?”, the system may, on detecting malware, or the possibility that one or more files may be affected by malware, take appropriate action in Step 306, “Report/Remove.” The action may, for instance, be to quarantine the particular files, to delete the files or to inform a management system or user of the existence, or possibility, of the threat, or some combination thereof.

If no malware is detected, the system may proceed to Step 307, “Continue Operations,” and then back on to Step 301, “Monitor Memory Access.”

Although this invention has been described with a certain degree of particularity, it is to be understood that the present disclosure has been made only by way of illustration and that numerous changes in the details of construction and arrangement of parts may be resorted to without departing from the spirit and the scope of the invention.

This disclosure of the various embodiments of the invention, with accompanying drawings, is neither intended nor should it be construed as being representative of the full extent and scope of the present invention. The images in the drawings are simplified for illustrative purposes and are not necessarily depicted to scale. To facilitate understanding, identical reference terms are used, where possible, to designate substantially identical elements that are common to the figures, except that suffixes may be added, when appropriate, to differentiate such elements.

Although the invention herein has been described with reference to particular illustrative embodiments thereof, it is to be understood that these embodiments are merely illustrative of the principles and applications of the present invention. Therefore, numerous modifications may be made to the illustrative embodiments and other arrangements may be devised without departing from the spirit and scope of the present invention. It has been contemplated that features or steps of one embodiment may be incorporated in other embodiments of the invention without further recitation.

1. An agentless method of scanning a digital memory for compromised security, comprising:
providing a digital memory storage device comprising one or more digital data blocks, each of said digital data blocks comprising a block address;
monitoring access to said digital memory storage device to compile a changed block list, said changed block list comprising one of more of said block addresses of said digital data blocks accessed since a last security scan; and
monitoring access to said digital memory storage device to compile a changed block list, said changed block list comprising one of more of said block addresses of said digital data blocks accessed since a last security scan; and performing a next security scan of only said digital data blocks on said changed block list.

2. The method of claim 1, wherein said changed block list comprises only said block addresses of said digital data blocks that have been both accessed and altered since said last security scan.

3. The method of claim 2, further comprising:
a digital host processor; and
a memory management module, operative on said digital host processor and wherein said memory management module comprises a journaling file system.

4. The method of claim 3, further comprising:
a file system driver, operative in a kernel mode on said host digital processor, and wherein said file system driver comprises instructions for implementing said function of monitoring access to said digital memory storage device to compile said changed block list.

5. The method of claim 4, wherein said digital memory further comprises a virtual digital memory associated with a virtual digital processing machine.

6. The method of claim 5, further comprising a hypervisor software module operative on said host digital processor, and wherein said file system driver is operative as an extension of said hypervisor software module.

7. The method of claim 6, wherein said next security scan comprises comparing digital data contained within one or more files stored on said digital data blocks having said block addresses contained in said changed block list with a signature of a known computer virus.
